(19) United States
(12) Patent Application Publication
(10) Pub. No.: US 2010/0050390 A1
(43) Pub. Date: Mar. 4, 2010

(54) GRIP MEMBER AND METHOD FOR INSTALLING THE GRIP MEMBER ONTO A SHAFT

(76) Inventor: Robert WU, Pingtung County (TW)

Correspondence Address: BERENATO & WHITE, LLC, 6550 ROCK SPRING DRIVE, SUITE 240, BETHESDA, MD, 20817, US

(21) Appl. No.: 12/547,831

(22) Filed: Aug. 26, 2009

(30) Foreign Application Priority Data
Sep. 2, 2008 (TW) 097133558

(51) Int. Cl. B25G 1/10; B23P 11/02

(52) U.S. Cl. 16/421; 29/446

(57) ABSTRACT

A method for installing a grip member onto a shaft includes: (a) providing the grip member with a surrounding wall that defines an insert space; (b) injecting a gas into the insert space to expand the surrounding wall; (c) moving the shaft into the insert space; and (d) allowing the surrounding wall to contract so that the grip member is fitted around the shaft. A structure of the grip member is also disclosed.

### CROSS-REFERENCE TO RELATED APPLICATION

This application claims priority of Taiwanese application no. 097133558, filed on Sep. 2, 2008.

### BACKGROUND OF THE INVENTION

1. Field of the Invention

This invention relates to a grip member and a method for installing the grip member onto a shaft.

2. Description of the Related Art

It is known to provide a grip member on a grip connecting portion of an article in practical use, such as a sickle, a scythe, a rasp, a kitchen knife, a ladle, a golf club, etc. Hereinafter, only the golf club is exemplified.

A conventional method for installing a golf grip member onto a golf shaft is disclosed in JP 2008-104710, and includes: foaming a solution containing water and a surfactant, filling an insert space of a grip member with the foamed solution, forming an aqueous adhesive layer on a grip connecting portion of a golf shaft, inserting the grip connecting portion of the golf shaft into the insert space of the grip member such that the aqueous adhesive layer is moistened by the foamed solution to become a mucous layer, followed by drying the grip connecting portion. Thereby, the grip member can be adhered to the golf shaft by the mucous layer.

However, the step of forming the aqueous adhesive layer on the grip connecting portion is usually conducted by winding a two-sided tape, which includes the aqueous adhesive layer on one side thereof, around an outer surface of the grip connecting portion. Because the winding step and the utilization of the adhesive layer will increase the cost of installation of the grip member, the conventional method for installing the grip member is unsatisfactory.

### SUMMARY OF THE INVENTION

Therefore, an object of the present invention is to provide a method for installing a grip member onto a shaft without using an adhesive layer or tape.

Another object of the present invention is to provide a grip member that can be installed on a shaft without using an adhesive layer or tape.

According to a first aspect of the present invention, there is provided a method for installing a grip member onto a shaft which comprises:

(a) providing the grip member with a resilient surrounding wall that defines an insert space for receiving a grip connecting portion of the shaft, the surrounding wall having an inner dimension that is normally smaller than an outer dimension of the grip connecting portion;

(b) injecting a gas into the insert space such that the surrounding wall is expanded and the inner dimension becomes larger than the outer dimension of the grip connecting portion;

(c) moving the grip connecting portion into the expanded surrounding wall until the grip connecting portion reaches a predetermined position; and

(d) allowing the surrounding wall to contract so that the grip member is fitted around the grip connecting portion.

According to a second aspect of the present invention, there is provided a grip member to be sleeved onto a tubular grip connecting portion of a shaft, which comprises:

a surrounding wall defining an insert space, and having an inner dimension not larger than an outer dimension of the grip connecting portion;

a cover closing one end of the surrounding wall and having a through bore communicated with the insert space and adapted for injection of a gas; and

a tubular projection projecting axially from an inner face of the cover into the insert space and having an axial connecting hole in spatial communication with the through bore and the insert space, the tubular projection being spaced apart from an inner surface of the surrounding wall so that an annular gap is formed between the surrounding wall and the tubular projection for receiving the grip connecting portion;

wherein the surrounding wall, the cover and the tubular projection are made of a resilient material, and the surrounding wall is expandable by a pressure of the gas injected into the insert space.

According to a third aspect of the present invention, there is provided a grip member to be sleeved onto a grip connecting portion of a shaft, which comprises:

a surrounding wall defining an insert space, and having an inner dimension not larger than an outer dimension of the grip connecting portion, and a plurality of pin holes each extending radially through inner and outer surfaces of the surrounding wail, the pin holes being spaced apart angularly and axially from each other; and

a cover closing one end of the surrounding wall and having a through bore communicated with the insert space and adapted for injection of a gas;

wherein the surrounding wall and the cover are made of a resilient material, and the surrounding wall is expandable by a pressure of the gas injected into the insert space.

The grip member can be a grip of a tool (for example, a sickle, a scythe or a rasp), a kitchen utensil (for example, a kitchen knife or a ladle), a sporting instrument (for example, a golf club), etc.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a flow chart showing a method for installing a grip member onto a shaft according to the first embodiment of the present invention;

FIG. 2 is a schematic view illustrating a golf club incorporating a grip member according to the present invention;

FIG. 3 is a sectional view of the grip member of the first embodiment and the golf club shaft shown in FIG. 2;

FIG. 4 is a sectional view illustrating that a grip connecting portion of the golf club shaft is fitted in one end of the grip member of FIG. 3;

FIG. 5 is a sectional view illustrating that a surrounding wall of the grip member is expanded by a gas injected into the grip member;

FIG. 6 is a sectional view illustrating that the grip connecting portion is clamped between the surrounding wall and a tubular projection of the grip member;

FIG. 7 is a fragmentary enlarged view illustrating that a lubricant forms a film layer between the surrounding wall and the grip connecting portion;

FIG. 8 is a transverse cross-sectional view illustrating that the lubricant in the grip member is vaporized and the grip connecting portion is clamped between the surrounding wall and the tubular projection;

FIG. 9 is a sectional view illustrating a grip member provided in the second embodiment according to the present invention;

FIG. 10 is a sectional view illustrating a grip member provided in the third embodiment according to the present invention; and

FIG. 11 is a transverse cross-sectional view of the grip member of FIG. 10.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

This invention is exemplified by using a golf club in the following embodiments. That is to say, a grip member of this invention is exemplified by using a grip member of the golf club, and a shaft is exemplified by using a golf club shaft.

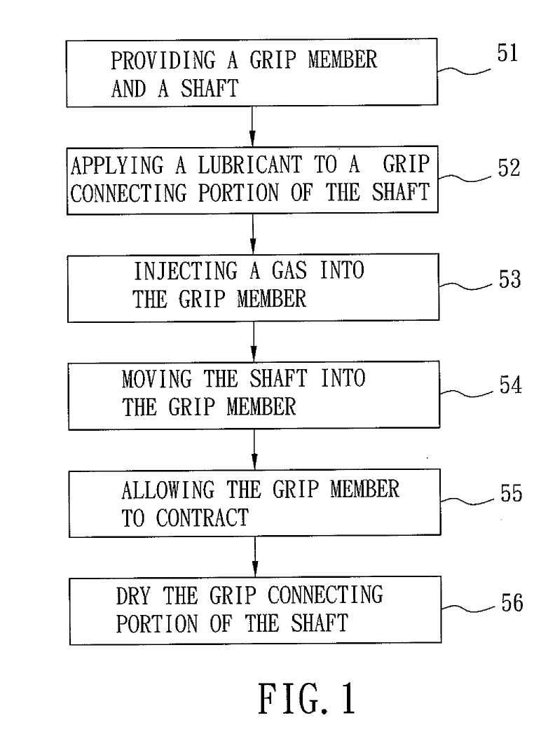

Referring to FIG. 1, a method for installing a grip member onto a shaft according to the present invention comprises: step 51 of providing a grip member and a shaft, step 52 of applying a lubricant to a grip connecting portion of the shaft, step 53 of injecting a gas into the grip member to expand the grip member, step 54 of moving the shaft into the grip member, step 55 of allowing the grip member to contract, and step 56 of drying the grip connecting portion of the shaft.

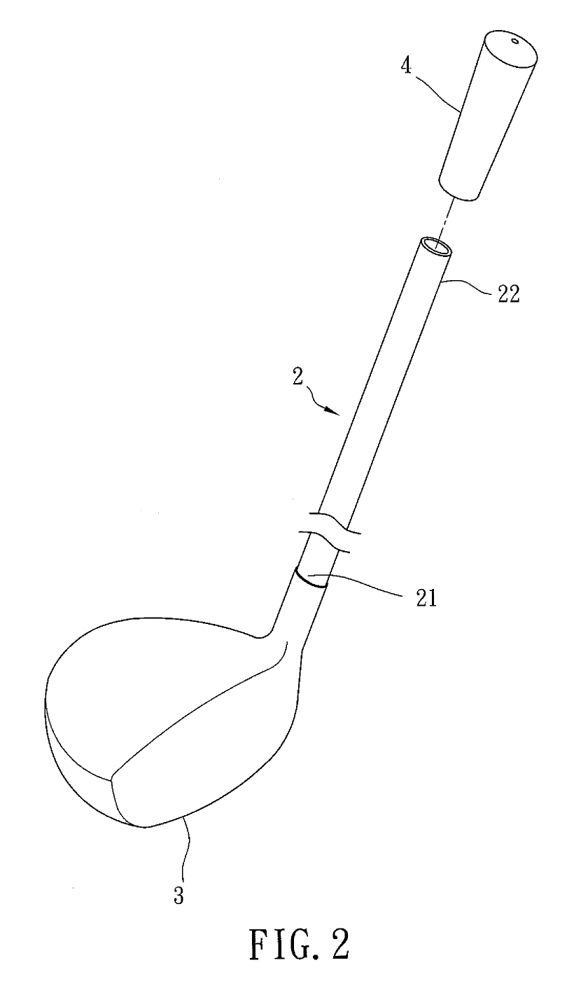

In step 51, the shaft 2 and the grip member 4 are provided. In this embodiment, a golf club head 3 is also provided (see FIG. 2).

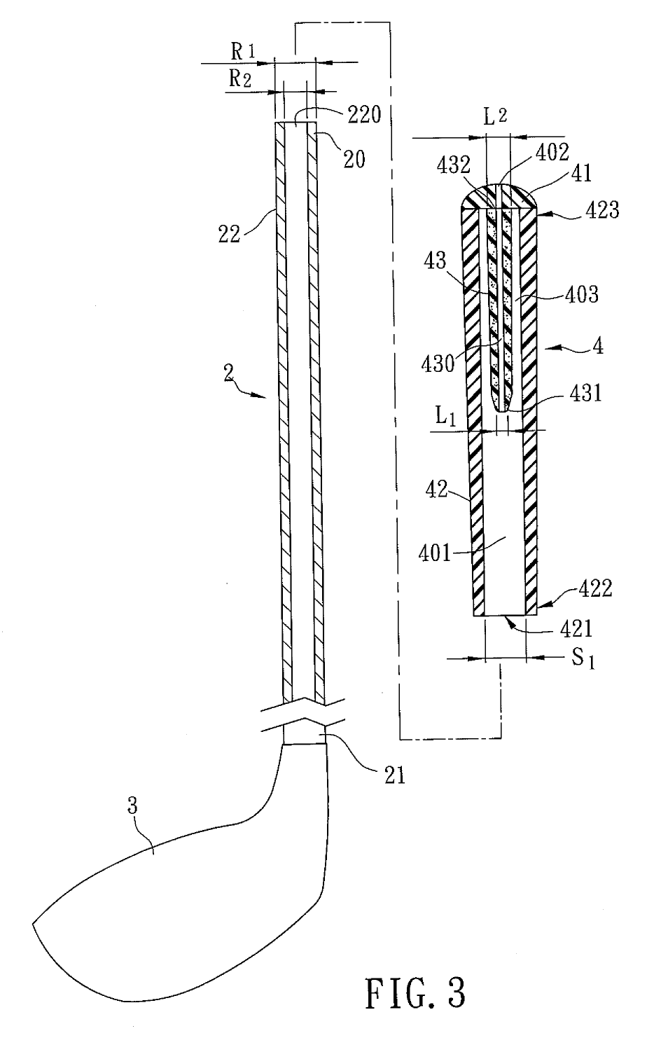

As best shown in FIG. 3, the shaft 2 is tubular and has two opposite ends 20, 21. The end 21 is connected to the golf club head 3. The shaft 2 further has a grip connecting portion 22 that is adjacent to the end 20 and that is formed with an inserting opening 220.

The grip member 4 includes a cover 41, a surrounding wall 42, and a tubular projection 43. The surrounding wall 42 defines an insert space 401 and has an inner dimension S₁ (which is an inner diameter in this embodiment) that is normally smaller than an outer dimension R₁ (which is an outer diameter in this embodiment) of the grip connecting portion 22. The surrounding wall 42 has two opposite ends 422, 423. The end 422 defines an opening 421 for access into the insert space 401. The end 423 is closed by the cover 41. The surrounding wall 42 has a thickness that is reduced gradually in a direction from the end 423 that is adjacent to the cover 41 to the end 422 away from the cover 41. The cover 41 has a through bore 402 communicated with the insert space 401 and adapted for injection of a gas.

The tubular projection 43 projects axially from an inner face of the cover 41 into the insert space 401, and has an axial connecting hole 430 in spatial communication with the through bore 402 and the insert space 401. The tubular projection 43 is spaced apart from an inner surface of the surrounding wall 42 so that an annular gap 403 is formed between the surrounding wall 42 and the tubular projection 43 for receiving the grip connecting portion 22.

The tubular projection 43 has an outer dimension L₂ (which is an outer diameter in this embodiment) larger than an inner dimension R₂ (which is an inner diameter in this embodiment) of the grip connecting portion 22, and includes a tapered free end 431 and a connecting end 432. The tapered free end 431 has an outer dimension L₁ (which is an outer diameter in this embodiment) smaller than the inner dimension R₂ of the grip connecting portion 22. The connecting end 432 is connected to the cover 41. The tubular projection 43 is deformable and is adapted to extend into the inserting opening 220 of the grip connecting portion 22.

Preferably, the tubular projection 43 has a length ranging from 1/10 to ½ of a length of the surrounding wall 42. In this embodiment, the length of the tubular projection 43 is ½ of that of the surrounding wall 42.

The cover 41, the surrounding wall 42, and the tubular projection 43 are made of a resilient material. The surrounding wall 42 is expandable by a pressure of the gas injected into the insert space 401. In this embodiment, the cover 41 and the surrounding wall 42 are made of rubber, and the tubular projection 43 is made of polyurethane.

Moreover, the tubular projection 43 can be made of other resilient material, for example, thermoplastic polyurethane, as long as the other resilient material is easier to deform than the material of the cover 41 and the surrounding wall 42.

In the preferred embodiment, the surrounding wall 42 is formed with an even inner surface, and the grip connecting portion 22 is provided with a smooth outer surface by a surface treatment (for example, by electroplating).

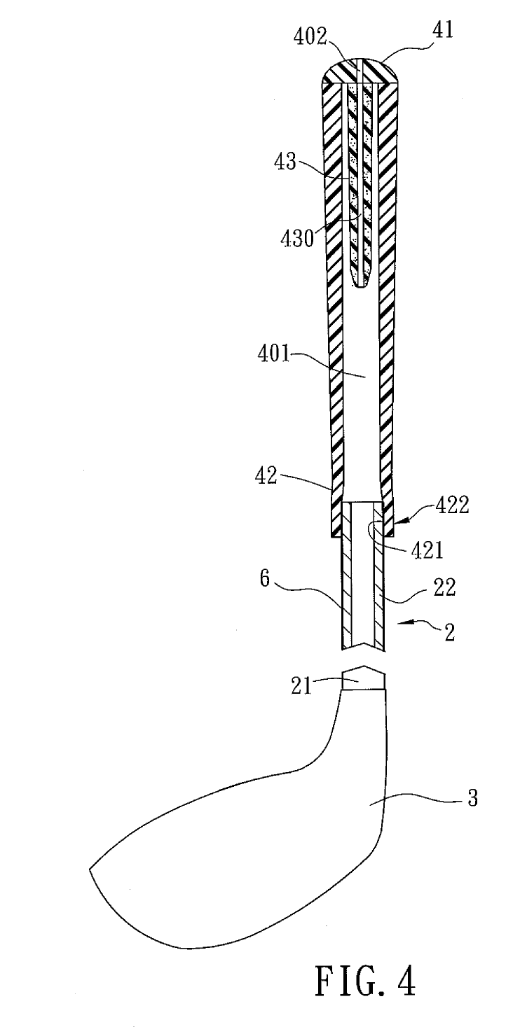

The step 52 is carried out by applying a lubricant 6 to an outer surface of the grip connecting portion 22 before the grip connecting portion 22 is moved into the insert space 401 (see FIG. 4).

In this embodiment, the lubricant 6 is water. Of course, the lubricant 6 can be any other liquid that can vaporize at normal temperature, such as ethyl alcohol.

As shown in FIG. 4, in step 53, one end 422 of the surrounding wall 42 that defines the opening 421 is enlarged, and the grip connecting portion 22 is fitted into the opening 421. At this state, it should be assured that the end 21 of the shaft 2 is in a closed state. The end 21 can be placed in the closed state by connecting the golf club head 3 to the end 21 or by putting a plug (not shown) into the end 21.

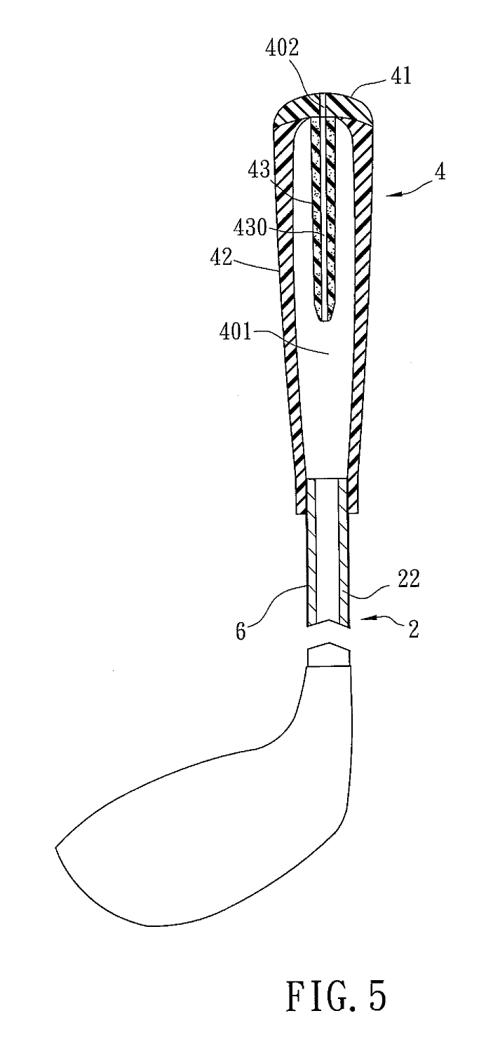

Afterwards, a gas is injected into the insert space 401 via the through bore 402 of the cover 41 such that the surrounding wall 42 is expanded and the inner dimension S₁ (see FIG. 3) becomes larger than the outer dimension R₁ (see FIG. 3) of the grip connecting portion 22, as shown in FIG. 5. In this embodiment, a high-pressure air is injected into the insert space 401.

In step 54, the grip connecting portion 22 is moved into the expanded surrounding wall 42, such as by pushing one of the shaft 2 and the grip member 4 relative to the other of the shaft 2 and the grip member 4, until the grip connecting portion 42 reaches a predetermined position.

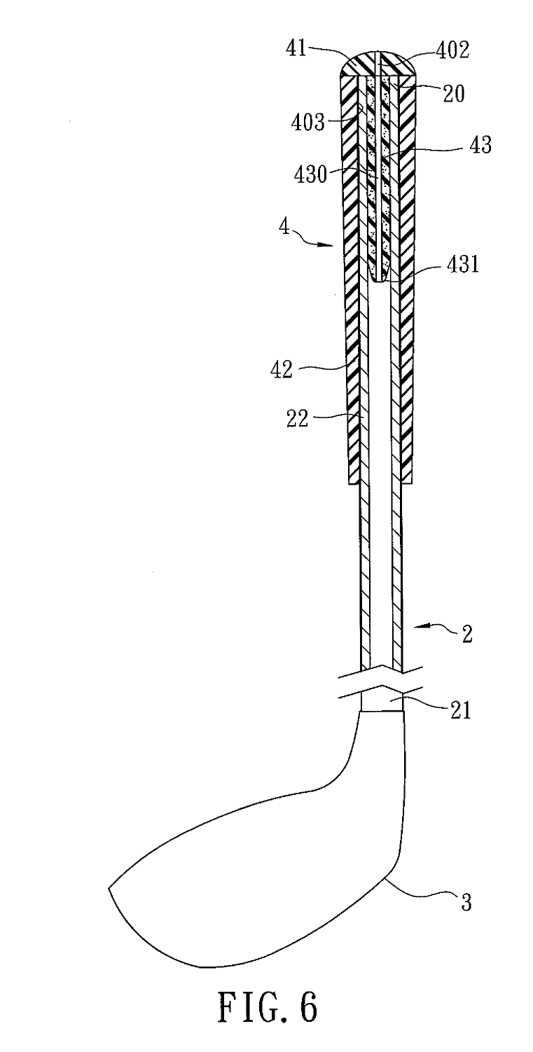

As shown in FIG. 6, at the predetermined position, the end 20 adjacent to the grip connecting portion 22 abuts against the inner face of the cover 41, and the tubular projection 43 extends fully into the grip connecting portion 22. At this position, the grip connecting portion 22 is received in the annular gap 403 between the surrounding wall 42 and the tubular projection 43.

Since the free end 431 is tapered, and since the outer dimension L₁ (see FIG. 3) of the free end 431 is smaller than the inner dimension R₂ (see FIG. 3) of the grip connecting portion 22, the free end 431, of course, can extend easily into the grip connecting portion 22 when the grip connecting portion 22 is moved into the insert space 401. Thereafter, since the outer dimension L₂ (see FIG. 3) of the tubular projection 43 is larger than the inner dimension R₂ of the grip connecting portion 22, the tubular projection 43 is squeezed into the grip connecting portion 22. Therefore, the tubular projection 43 should be compressible enough so as to reduce the resistance to the movement of the grip connecting portion 22 relative to the tubular projection 43.

The surrounding wall 42 should be expandable when pressurized by the gas and should have a thickness sufficient to provide a cushioning effect. Therefore, the surrounding wall 42 must be resilient enough to expand and to cushion. In this embodiment, the degree of resiliency of the tubular projection 43 is larger than that of the surrounding wall 42.

In step 55, the injection of the gas is stopped, and the surrounding wall 42 of the grip member 4 is allowed to contract. At this state, the through bore 402 is placed in an open state to allow the gas to flow out of the insert space 401 while the grip connecting portion 22 is moved into the insert space 401.

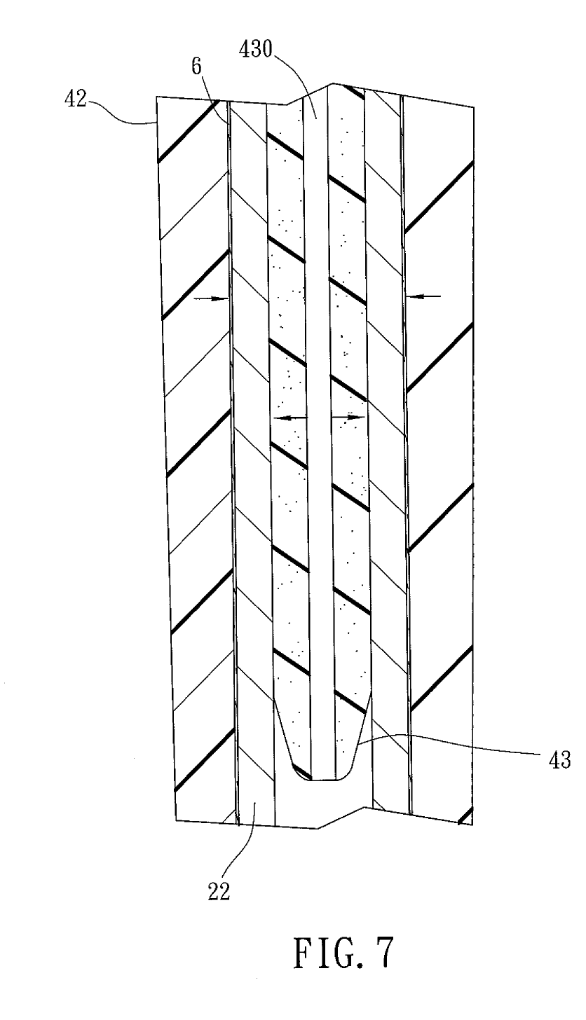

Referring to FIG. 7, the lubricant 6 forms a layer between the grip connecting portion 22 and the surrounding wall 42 so that the grip member 4 is rotatable. At this state, the surrounding wall 42 contracts inward as shown by arrows, and the tubular projection 43 has restored back as shown by arrows. The grip connecting portion 22 is therefore clamped by the surrounding wall 42 and the tubular projection 43. In step 56, the grip connecting portion 22 is dried by allowing the lubricant 6 to vaporize and to be released out of the insert space 401.

In this embodiment, the vaporization of the lubricant 6 is carried out at room temperature (normal temperature). Alternatively, the step 56 can be carried out at a higher temperature to accelerate the vaporization.

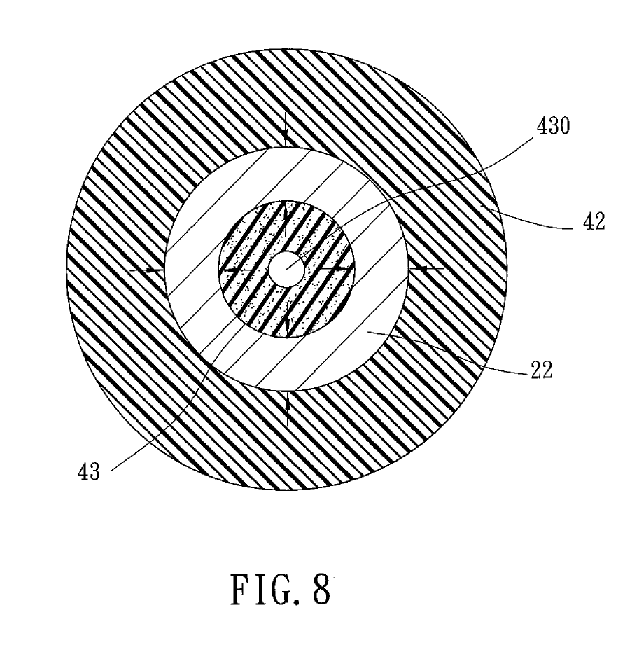

After step 56, the grip connecting portion 22 is clamped more tightly by the surrounding wall 42 and the tubular projection 43 as shown in FIG. 8. Because both of the inner surface of the surrounding wall 42 and the outer surface of the grip connecting portion 22 are even, the grip connecting portion 22, after drying, can be in tight abutment with the surrounding wall 42 without forming any clearance therebetween.

In addition, since the outer dimension R₁ (see FIG. 3) of the grip connecting portion 22 is larger than the inner dimension S₁ (see FIG. 3) of the surrounding wall 42, the grip member 4 can be tightly fitted around the grip connecting portion 22. Accordingly, the grip member 4 can be assembled on the shaft 2 without using any adhesive that contains polluting solvent.

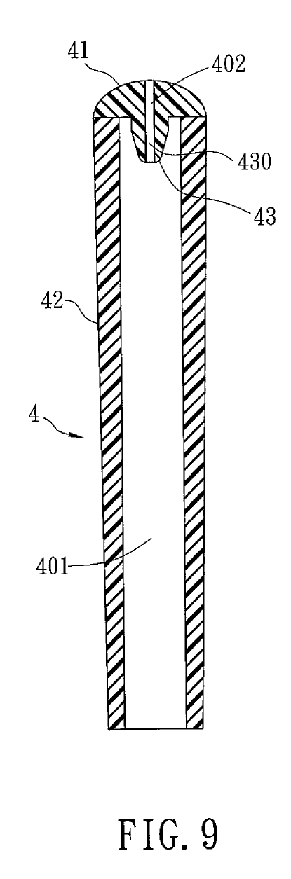

FIG. 9 illustrates a grip member 4 provided in the second embodiment according to the present invention. The second embodiment differs from the first embodiment only in that the length of the tubular projection 43 is 1/10 of that of the surrounding wall 42.

Because the length of the tubular projection 43 in this embodiment is much shorter than that of the first embodiment, the cover 41, the surrounding wall 42, and the tubular projection 43 can be formed integrally as one piece. Of course, for appearance of the grip member 4, the cover 41 and the surrounding wall 42 can be formed individually to have different colors, and then integrated to form a unitary body.

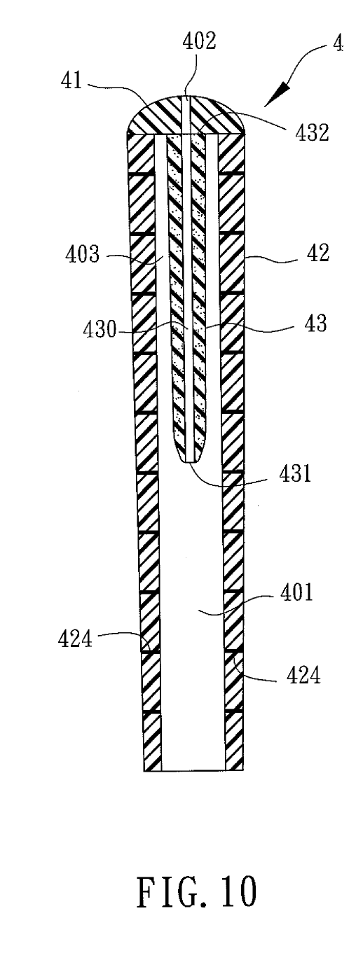

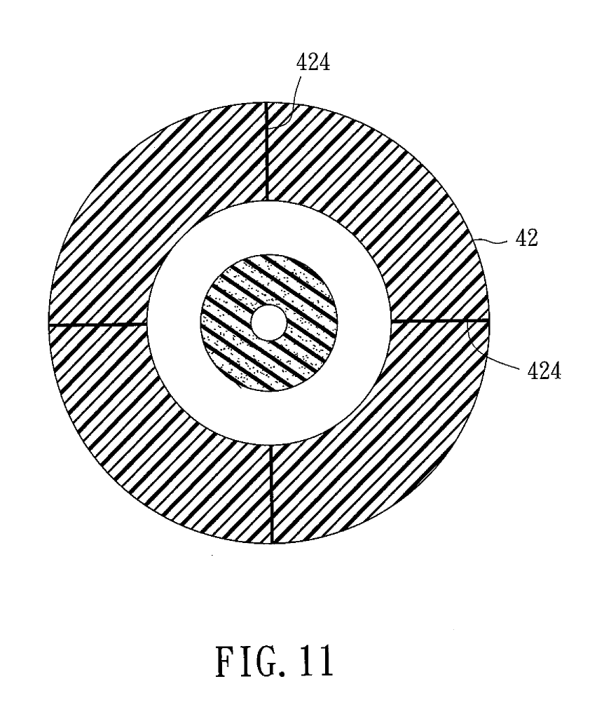

FIGS. 10 and 11 illustrate a grip member 4 provided in the third embodiment according to the present invention.

The third embodiment differs from the first embodiment only in that the surrounding wall 42 of the grip member 4 is formed with a plurality of radial pin holes 424 in spatial communication with the insert space 401. By such, the lubricant 6 is releasable through the pin holes 424 after vaporizing.

In this embodiment, each of the pin holes 424 extends radially through inner and outer surfaces of the surrounding wall 42, and the pin holes 424 are spaced apart angularly and axially from each other.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A method for installing a grip member onto a shaft, comprising:
(a) providing the grip member with a resilient surrounding wall that defines an insert space for receiving a grip connecting portion of the shaft, the surrounding wall having an inner dimension that is normally smaller than an outer dimension of the grip connecting portion;
(b) injecting a gas into the insert space such that the surrounding wall is expanded and the inner dimension becomes larger than the outer dimension of the grip connecting portion;
(c) moving the grip connecting portion into the expanded surrounding wall until the grip connecting portion reaches a predetermined position; and
(d) allowing the surrounding wall to contract so that the grip member is fitted around the grip connecting portion.

2. The method of claim 1, further comprising applying a lubricant to an outer surface of the grip connecting portion before the grip connecting portion is moved into the surrounding wall.

3. The method of claim 2, further comprising drying the grip connecting portion by allowing the lubricant to vaporize and to be released out of the insert space.

4. The method of claim 1, wherein one end of the grip connecting portion is fitted into one end of the surrounding wall when the gas is injected into the insert space.

5. The method of claim 1, wherein, in step (d), the surrounding wall is allowed to contract by causing the gas to flow out of the insert space.

6. The method of claim 1, wherein the surrounding wall of the grip member has a cover that closes one end of the surrounding wall, the cover having a through bore, the gas being injected into the insert space via the through bore.

7. The method of claim 6, wherein the cover is formed with a tubular projection which extends from an inner face of the cover into the insert space and which has a connecting hole in spatial communication the through bore and the insert space, the grip connecting portion is tubular, and the tubular projection extends into the grip connecting portion which is moved into the insert space.

8. The method of claim 3, wherein the lubricant is a liquid that can vaporize at normal temperature.

9. The method of claim 8, wherein the lubricant is selected from the group consisting of water and ethyl alcohol.

10. The method of claim 9, wherein the surrounding wall is formed with a plurality of radial pin holes in spatial communication with the insert space, the lubricant being releasable through the pin holes after vaporizing.

11. A grip member to be sleeved onto a tubular grip connecting portion of a shaft, comprising:
a surrounding wall defining an insert space, and having an inner dimension not larger than an outer dimension of the grip connecting portion;
a cover closing one end of said surrounding wall and having a through bore communicated with said insert space and adapted for injection of a gas; and
a tubular projection projecting axially from an inner face of said cover into said insert space and having an axial connecting hole in spatial communication with said through bore and said insert space, said tubular projection being spaced apart from an inner surface of said surrounding wall so that an annular gap is formed between said surrounding wall and said tubular projection for receiving the grip connecting portion;
wherein said surrounding wall, said cover and said tubular projection are made of a resilient material, and said surrounding wall is expandable by a pressure of the gas injected into said insert space.

12. The grip member of claim 11, wherein said tubular projection has an outer dimension larger than an inner dimension of the grip connecting portion.

13. The grip member of claim 12, wherein said tubular projection further has a tapered free end opposite to said cover.

14. The grip member of claim 11, wherein said tubular projection has a length ranging from 1/10 to ½ of a length of said surrounding wall.

15. The grip member of claim 12, wherein said surrounding wall and said cover are made of rubber, and said tubular projection is made of polyurethane.

16. The grip member of claim 11, wherein said surrounding wall has a plurality of pin holes each extending radially through inner and outer surfaces of said surrounding wall, said pin holes being spaced apart angularly and axially from each other.

17. A grip member to be sleeved onto a grip connecting portion of a shaft, comprising:
a surrounding wall defining an insert space, and having an inner dimension not larger than an outer dimension of the grip connecting portion, and a plurality of pin holes each extending radially through inner and outer surfaces of said surrounding wall, said pinholes being spaced apart angularly and axially from each other; and
a cover closing one end of said surrounding wall and having a through bore communicated with said insert space and adapted for injection of a gas;
wherein said surrounding wall and said cover are made of a resilient material, and said surrounding wall is expandable by a pressure of the gas injected into said insert space.
